(19) United States
(12) Patent Application Publication
(10) Pub. No.: US 2026/0018315 A1
(43) Pub. Date: Jan. 15, 2026

(54) METHOD AND APPARATUS FOR LOADING OPTICAL TRAPS

(71) Applicants: Bruno Ximenez, Massy (FR); Etienne Bloch, Massy (FR); Davide Dreon, Massy (FR); Adrien Signoles, Massy (FR); Kai-Niklas Schymik, Massy (FR); Pascal Scholl, Palaiseau (FR); Daniel Barredo, Madrid (ES); Antoine Browaeys, Paris (FR); Thierry Lahaye, Paris (FR)

(72) Inventors: Bruno Ximenez, Massy (FR); Etienne Bloch, Massy (FR); Davide Dreon, Massy (FR); Adrien Signoles, Massy (FR); Kai-Niklas Schymik, Massy (FR); Pascal Scholl, Palaiseau (FR); Daniel Barredo, Madrid (ES); Antoine Browaeys, Paris (FR); Thierry Lahaye, Paris (FR)

(21) Appl. No.: 18/993,858

(22) PCT Filed: Jul. 13, 2022
(86) PCT No.: PCT/IB2022/000473

§ 371 Date: Jan. 13, 2025

(51) Int. Cl. G21K 1/00

(52) U.S. Cl. CPC G21K 1/006

(57) ABSTRACT

A system and method are provided of controlling a plurality of optical traps. The method comprises: generating the plurality of optical traps. each optical trap (“i”) having a trap intensity: measuring trap loading rates for each trap; minimizing differences between trap loading rates of different traps. the minimizing comprising adjusting of at least some of the traps the trap intensity to a further trap intensity based on the trap loading rates.

### CROSS-REFERENCE TO RELATED APPLICATION

This Application is a Section 371 National Stage Application of International Application No. PCT/IB2022/000473, filed Jul. 13, 2022 and published as WO/2024/013536 A1 on Jan. 18, 2024, in English.

### TECHNICAL FIELD

The present disclosure relates to controlling a loading rate of a plurality of optical traps, in particular to equalizing loading rates of optical traps for neutral atoms.

### BACKGROUND

There are currently several approaches for building quantum systems with the goal of quantum computation and simulation. One of the approaches is based on neutral atoms as quantum registers. These atoms are trapped on arrays of optical traps, commonly referred to as optical tweezers, which are tightly focused laser beams produced by sending a beam into a beam-shaping device and high-numerical aperture optics. A spatial light modulator (“SLM”) can be used as a suitable beam-shaping device, enabling arranging the tweezers in programmable arbitrary geometric patterns in 1D, 2D or 3D shapes.

The tweezers provide dipole traps, in which atoms can be loaded and maintained. Generally, each trap can be filled with either zero or one atom. Increasing the number of atoms then necessarily implies increasing the number of traps generated, which means larger overall sizes of the geometric pattern of the optical traps. When increasing the number of traps to the scale of hundreds or thousands, optical aberrations become a feature of the optical system which deforms the spatial shape of the trap intensity beams that are far off (optical) axis. Those aberrations lead to smaller local maximum laser intensity which introduces intensity inhomogeneity on the pattern, degrading the effective trap depth seen by the atoms which leads to lower trapping rates, and in severe cases, completely suppressing the ability to trap an atom. This problem prevents an efficient filling of the array and needs to be solved to scale up the technology to large number of qubits.

Such problem of inhomogeneous trapping in a plurality of optical traps can also occur in when trapping other objects than atoms such as molecules or even larger objects such as microspheres for biological assays.

The techniques developed so far to improve the homogeneity of tweezer arrays in the field of trapping neutral atoms are based on direct or indirect measurement of the intensity of the trapping light, which is used to feedback the beam shaping device. The feedback can be calculated
1. from a direct measure of the light intensity using a camera;
2. from an atomic signal proportional to the trap depth;
3. as in 1, but the camera being calibrated on an atomic signal.

Technique #1 is disclosed in Nogrette et al., “Single-Atom Trapping in Holographic 2D Arrays of Microtraps with Arbitrary Geometries”, Phys. Rev. X 4, 021034 (2014), DOI: 10.1103/PhysRevX.4.021034.

In this article, the authors increase the degree of uniformity of the trap depths by use of a CCD camera as an intensity diagnostic. A diagnostic optical system takes an in-situ image of the traps and measures the intensity of each trap. This signal is used to calculate feedback for the trap production system (in this article an SLM), which updates the target intensity pattern such that the camera records uniform intensities across the array.

For small scale arrays, intensity standard deviations of a few % are achieved. This technique #1 has an important limitation because it relies on the assumption of having a perfect optical setup for imaging the traps. However, the diagnostic optical setup induces additional aberrations on the signal detected on the CCD camera. Therefore, equalizing the intensities on the camera may not necessarily lead an accurate equalization of the traps in-situ.

Technique #2 is disclosed in Endres et al., “Atom-by-atom assembly of defect-free one-dimensional cold atom arrays” Science, 354 (6315), 1024 (2016), DOI: 10.1126/science.aah3752, and in Singh et al., “Dual-Element, Two-Dimensional Atom Array with Continuous-Mode Operation” Physical Review X 12, 011040 (2022), DOI: 10.1103/PhysRevX.12.011040.

Both these articles rely on a measurement of an atomic signal as direct feedback for the beam shaping device for producing the traps (acousto-optic deflector (“AOD”) and spatial light modulator (“SLM”) respectively). In this way the correction feedback is independent on the optical setup. In this case, the atomic signal is the differential AC Stark shift (light-shift) due to the trap light. An inhomogeneity in the trap depths results in different light-shifts across the array. The authors achieve an AC Stark shift (light-shift) uniformity over the whole trap array of 2% and 4% RMS, respectively. In their follow-up studies, the group of Endres et al. uses also an SLM and feedbacks the light shift measurement not only to the intensities but also to a phase correction algorithm.

Note that these last techniques measuring the AC Stark shift require an additional tunable laser to perform a site-by-site spectroscopy on the trapped atoms. In addition, the light shift measurement only relies on the trap depth and requires to have atoms in the trap with a high probability, in order to have a good signal to noise ratio.

Technique #3 is disclosed in Jenkins et al, “Ytterbium nuclear-spin qubits in an optical tweezer array”, arXiv: 2112.06732, DOI: 10.48550/arXiv.2112.06732.

This technique is largely a combination of the previous ones. The authors also rely on the feedback from a diagnostic optical setup that images the traps. Differently from the Technique #1, the traps are measured with light picked off before the objective lens. However, to overcome the limitation of Technique #1 that uniform intensity at the camera does not guarantee uniform intensity in-situ, the intensities measured by the diagnostic camera are previously calibrated on an atomic signal. Also in this case, the authors rely on an AC Stark shift measurement. By iterating, the authors measure a final reduction of the light shift spread of 1.4%

Although the equalization procedures of these publications improve achieving uniform intensity of the trap light, improvements in controlling loading of an optical trap array are desired.

### SUMMARY

Herein a method of controlling a plurality of optical traps, and an associated apparatus are provided. The optical traps may be used to trap objects serving as qubits for quantum computation and/or quantum communication. E.g. objects trapped in the plurality of optical traps may serve as a quantum register.

An embodiment comprises controlling the traps based on analysis of the evolution of trapping rates of each trap as a function of an overall trapping intensity, and in particular an overall trap power.

In particular, a method of controlling a plurality of optical traps as provided herein comprises: generating the plurality of optical traps, each optical trap (“i”) having a trap intensity; measuring trap loading rates for each trap; and minimizing differences between trap loading rates of different traps.

The minimizing comprising adjusting of at least some of the traps the trap intensity to a further trap intensity based on the trap loading rates.

Thus, in the present case, a homogeneous loading rate of the traps is aimed for. This is in contrast to the aforementioned solutions in which the goal of the equalization procedure is always to achieve homogenous traps by uniform intensity of the trap light. In particular, in the present case the loading rate may be a loading rate for neutral atoms, more in particular for single neutral atoms. Thus, each trap is assessed with respect to the actual trapping result, rather than with respect to a preparation for any result. This provides an accurate measure of the efficiency of the trapping of each trap and therefore provides an effective feedback mechanism. The loading rate is a quantity that directly helps increasing the size of the array itself. A larger array may hold more qubits for quantum computation, thus allowing increasing complexity and/or speed of quantum calculations. Note that the more reliably the traps can be loaded, the more reliable and/or faster quantum operations using (objects trapped in) the traps may be performed and/or be repeated, further increasing fidelity thereof.

Since optical intensity is proportional to optical power, in any of the present concepts the intensity may suitably be approximated by power. This applies in particular if spatial variations are absent or negligible at least over the optical traps under consideration, such as variations in optical beam focus shape and/or size, and variations in number and/or arrangement of division of optical traps derived from one or more initial optical beams (see also below), etc. It should be noted that herein “optical” and/or “light” relates to electromagnetic radiation having a wavelength in the range of 11-0.2 micrometer; ranging from (deep) InfraRed to (deep) UltraViolet, however, use of wavelengths in the range 2.5-0.3 micrometer or 1.2-0.4 micrometer may be preferred for trapping particular types of objects and/or for facilitating selection of optical elements such as lenses, windows, mirrors.

As a result, the final array after the loading-rate equalization according to the present concepts may not necessarily be trap depth equalized, but may be uniformly loaded with a particular filling fraction, e.g. 50-60%. In addition, the presently provided method can work with very inhomogeneous arrays where the aberrations are so strong that almost no atoms are detected, a situation that would prevent the use of techniques that require sufficient signal to perform spectroscopy, such as technique #2 discussed above.

In the method, the measuring may further comprise
measuring the trap loading rates for each trap as a function of the trap intensity and/or as a function of an overall trap intensity for the plurality of optical traps;
fitting a function to the measured trap loading rates for each trap and determining a fit parameter for each trap; and
wherein the minimizing comprises adjusting of at least some of the traps the trap intensity to the further trap intensity based on the fit parameter.

This provides significantly improved equalization of the trap loading rates compared to the known techniques and even to assessing each trap as indicated above. The fit parameter allows relative adjustment of the trap intensities, thus facilitating equalizing the traps to each other.

It has been found that optical traps may tend to exhibit the same intensity dependent trapping rate behavior. Therefore, the traps may be fit with the same function and one or more fit parameters may be determined with which the intensity dependent trapping rate behavior of different traps may be scaled to each other. This facilitates comparison and minimizing differences.

Measuring an overall trap intensity for the plurality of optical traps may simplify the method over measuring the trap loading rates for each trap as a function of the trap intensity.

The fit parameter of at least one of the traps, preferably of each of the traps, may be associated with a trap intensity of the respective trap with respect to at least one of a total intensity for all traps, a total intensity of all traps, an average trap intensity for the plurality of optical traps, and an average trap intensity of the plurality of optical traps.

Thus, the loading rates of each trap are related to the overall trap intensity. directly or indirectly via accounting for the number of traps. This may facilitate minimizing difference in terms of practical experimental and/or operational parameters. In particular, the total intensity for all traps may be known and/or be controlled more accurately than the intensity per trap. E.g., all optical traps may be generated by division of a single initial light beam (in particular a laser beam), and the intensity of the initial light beam may be readily determined. Also, equalizing the trapping rate over the plurality of traps may be considered more important than the trapping rate as such, since generally increasing intensity of an optical trap will increase trapping rates. Embodiments of the present method may therefore facilitate establishing a minimum difference first and an optimum intensity per trap and/or an optimum intensity for the plurality second. The fit parameter being associated with a relative trap intensity with respect to the total intensity facilitates control over the plurality of traps while maintaining at least partly the minimized difference.

A total intensity for all traps and an associated average trap intensity may be determined from an intensity of an initial light beam that is divided over the optical traps (pₜₒₜ; p_{avg,tot}=Pₜₒₜ/Nₜ), or from a sum over (the optical beams producing) the optical traps; (Σᵢ pᵢ; P_{avg,i}=Σᵢ pᵢ/Nₜ). Using the initial light beam facilitates the method an associated system.

The fitting may further comprise determining the loading rate as a function of a target loading rate for at least one of the traps, in particular a maximum trap loading rate for at least one of the traps.

Determining the trap loading with respect to a target loading rate facilitates qualitative comparison between the traps. This assists minimizing differences. The target trap loading rate may in particular be a maximum trap loading rate.

The fitting function may be normalized to the target trap loading rate. The target loading rate, in particular the maximum loading rate, may be determined by one or more of measurement, extrapolation and assumption, e.g. being determined as an asymptotic value. A maximum trap loading rate may be determined with respect to a target load of the trap, e.g. trapping of a single atom in the trap. Determining a maximum loading rate may be done qualitatively and/or be independent of particular detection methods and/or be independent of systematic defects in a particular detection method (e.g. optical aberrations).

The fitting may comprise fitting an error function (Erf) to the measured trap loading rates on the basis of

$${η}_{i} ( p ) = 1 / 2 {η}_{max , i} \{ Erf [ α ( {p}_{avg} - {P}_{half , i} ) ] + 1 \} \qquad ( 1 )$$

wherein ηᵢ is a trap loading rate for a trap i, η_{max,i} is a maximum loading rate for the trap i, α is a constant, p_{avg} is an average intensity per trap (p_{avg} preferably being p_{avg,tot} or P_{avg,i}), and P_{half,i} is the fit parameter for each trap.

The error function has been found to provide a suitable and robust fitting function. This may be associated with the stochastic nature of trapping of trapping objects from a background, e.g. optical traps trapping neutral atoms.

In the function, P_{half,i} is associated with the average intensity per trap at which the trap i reaches half its asymptotic loading rate η_{max,i}; this may be associated with a mid-point of the loading rate function. Minimizing differences between traps may amount to minimizing differences in P_{half,i} between the traps.

The generating may comprise generating the plurality of optical traps by distributing a light having a first optical intensity among the traps, in particular dividing an initial light beam into a plurality of light beams each providing an optical trap.

This may facilitate generation and/or control over the traps. E.g. this facilitates control and/or measuring trap loading rates as a function of trap power for all traps, the power per trap being dependent on the available total power. The (light having the) first optical intensity may be derived from one or more trapping light sources, in particular one or more lasers, and it may be provided by or in the form of a single (laser) beam. A single (laser) beam may be divided into separate optical tweezers to provide the traps.

The distribution may comprise weighted distribution. For that, the weights may be associated with the fit parameters. The adjusting may then comprise distributing the optical power among the traps based on the fit parameters.

The distribution may be provided using a spatial light modulator (SLM), e.g. one or more of phase spatial light modulators, holographic phase spatial light modulators, acousto-optic deflectors (AODs), electro-optic deflectors (EODs), digital mirror devices (DMDs) etc.

The distribution and any associated weights may be maintained or changed with changing of the first optical power.

The measuring may further comprise measuring an optical signal, e.g. luminescence and/or scattering, of trapped target objects.

Although several methods may be used for detection of presence or absence of a trapped object in the trap, measuring of an optical signal of the trapped object may be most reliable and most closely connected with the aim of the method itself. This facilitates obtaining a reliable signal of presence or absence of a trapped object in the trap. The optical signal of a trapped object in a trap may comprise or be derived from luminescent processes of the trapped object and/or from fluorescence and/or scattering of light from and/or caused by the trapping beam. Also or alternatively optical excitation processes may be used, e.g. illuminating one or more traps with light allowing or urging light emission and/or-scattering by one or more trapped objects.

The measuring may further comprise obtaining a signal indicative of a time averaged presence of a target object in the trap.

A quantity that is directly correlated to the trap quality is the probability of trapping an object, in particular: an atom. The loading rate is the physical quantity that corresponds to this probability. The loading rate may be defined as the average of an ensemble of detection measurements: Pᵢ=<X_{i,k}>. Here, the output x_{i,k} of a measurement k may be a Boolean value 0 (1) representing no (an) object (in particular: an atom) detected, for each trap i. This amounts to an averaged presence of an object in the trap; considering timing of detection measurements a temporal average may be obtained. Thus, the loading rate of a trap is then a continuous variable ranging from 0 to 1. Also or alternatively, in practice fluorescence of trapped objects (e.g. atoms) can be detected and/or accumulated over a suitable period of time allowing several instances of trapping and losing an object, so that a trapping rate can be determined based on a time averaged occupancy of the trap. A suitable measurement time and/or averaging time may be determined in terms of an expected and/or desired survival time in the trap, e.g. at least 2× the survival time, preferably at least 5 times, more preferably at least 10 times, most preferably at least 25 times, such as 50 times the survival time or more. The larger the number, the better statistics may be determined and the better equalization can be achieved. Note that the expected survival time of an object in a trap may depend on various experimental properties; e.g. in atomic samples the atomic temperature distribution, background pressure, detuning of a trapping beam from a resonance condition, etc.

In a preferred case for optical trapping of atoms, the loading rate may range between 0.5 and 0.6, i.e. an average occupancy of between 50% and 60%, while being significantly lower for lower quality traps, e.g. aberrated traps far from the optical axis of an optical system generating the traps. The present concepts allow reaching such values of between 0.5 and 0.6 for most or all traps.

The generating may comprise use of a holographic spatial light modulator. Preferably the minimizing comprises calculating a phase pattern for the holographic spatial light modulator according to the Weighted Gerchberg-Saxton algorithm and adjusting the phase pattern on the basis of w_{i,new}=(Nₜ p_{half,i}/Pₜₒₜ)w_{i,old}

Thus, the determined P_{half,i} values for the traps may be used to adjust the phase pattern.

The adjustment may also or alternatively comprise calculating a correction function C(p_{half,i}) for updating trap intensities generated by the spatial light modulator, such that the new traps are calculated from the previous values via proportional feedback T_{i,new}=C(p_{half,i}) T_{i,old}. Suitably,

$$C ( {p}_{half , i} ) = \frac{1}{1 - G ( 1 - \sqrt{\frac{< {p}_{half , i} >}{{p}_{half , i}}} )} \qquad ( 2 )$$

wherein <p_{half,i}> denotes an average over p_{half,i} of all traps i.

Any method herein may further comprise moving a trapped object from one of the traps to another one of the traps.

This may assist providing an array of filled traps of a desired array layout. Also or alternatively, this may assist positioning object in a configuration for quantum computation, e.g. providing a particular distance between objects for establishing a desired interaction strength. The disclosed concepts facilitate selection of one or more traps from which an object is to be moved and/or trapping and holding the object in both old and new traps similarly.

Any method herein may be used for quantum computation and/or quantum communication. Objects held in the traps may serve for qubits, e.g. neutral atoms prepared in particular states and/or superpositions of states. Due to the improved uniformity of the array of traps, establishing and/or control of (evolution of) states of the trapped objects is improved.

Associated with the above and any effects and benefits thereof, herewith an optical trapping system is provided, comprising
an optical system for generating a plurality of optical traps;
a measuring unit for measuring trap loading rates for each trap; and,
a computer configured to execute the steps of:
generating, using the optical system, a plurality of optical traps, each optical trap having a trap intensity;
measuring, using the measuring unit, trap loading rates for each trap;
minimizing differences between trap loading rates of different traps, the minimizing including adjusting the trap intensity of at least some of the traps to a further trap intensity based on the trap loading rates.

The system may further comprise a source of neutral atoms, molecules or ions for being trapped in the traps.

Also or alternatively, the optical system may comprise a spatial light modulator for controllably distributing an optical intensity from a light source among the traps.

The system facilitates trapping and holding objects, in particular atoms.

For that, the system may comprise a source of neutral atoms, molecules or ions for being trapped in the trap.

The optical system may comprise a spatial light modulator for controllably distributing an optical power from a light source among the traps.

The optical trapping system may be particularly well suited for performing quantum computation operations.

A quantum computer may comprise the optical trapping system, in particular for trapping ions and/or neutral atoms as qubits; e.g. an array of ions and/or neutral atoms held in the optical traps may form a qubit register.

Herewith further are provided a computer program product comprising instructions to cause the disclosed optical trapping to execute the steps of any method embodiment disclosed herein. Further is provided a computer-readable medium having stored thereon the computer program product.

In particular, a system for the method disclosed herein may comprise a computer comprising a computer readable storage medium having computer readable program code embodied therewith, and a processor, preferably a microprocessor, coupled to the computer readable storage medium, wherein responsive to executing the computer readable program code, the processor is configured to perform the method according to one or more of the embodiments described herein.

Further, a computer program or suite of computer programs comprising at least one software code portion or a computer program product storing at least one software code portion, the software code portion, when run on a computer system, being configured for executing the method according to one or more of the embodiments described herein may be provided.

A non-transitory computer-readable storage medium may store at least one software code portion, the software code portion, when executed or processed by a computer, is configured to perform the method according to one or more of the embodiments described herein

### BRIEF DESCRIPTION OF THE DRAWINGS

The above-described aspects will hereafter be more explained with further details and benefits with reference to the drawings showing a number of embodiments by way of example.

FIG. 1 schematically shows an optical trapping system;

FIGS. 2, 3 and 4 indicate method steps and associated measurement results for methods disclosed herein;

FIG. 5 indicates method steps disclosed herein;

FIGS. 6, 7 and 8 schematically illustrate a quantum computer comprising an optical trapping system as disclosed herein, and associated quantum operations.

### DETAILED DESCRIPTION OF EMBODIMENTS

It is noted that the drawings are schematic, not necessarily to scale and that details that are not required for understanding the present invention may have been omitted. The terms “upward”, “downward”, “below”, “above”, and the like relate to the embodiments as oriented in the drawings, unless otherwise specified. Further, elements that are at least substantially identical or that perform an at least substantially identical function are denoted by the same numeral, where helpful individualised with alphabetic suffixes.

Further, unless otherwise specified, terms like “detachable” and “removably connected” are intended to mean that respective parts may be disconnected essentially without damage or destruction of either part, e.g. excluding structures in which the parts are integral (e.g. welded or moulded as one piece), but including structures in which parts are attached by or as mated connectors, fasteners, releasable self-fastening features, etc. The verb “to facilitate” is intended to mean “to make easier and/or less complicated”, rather than “to enable”.

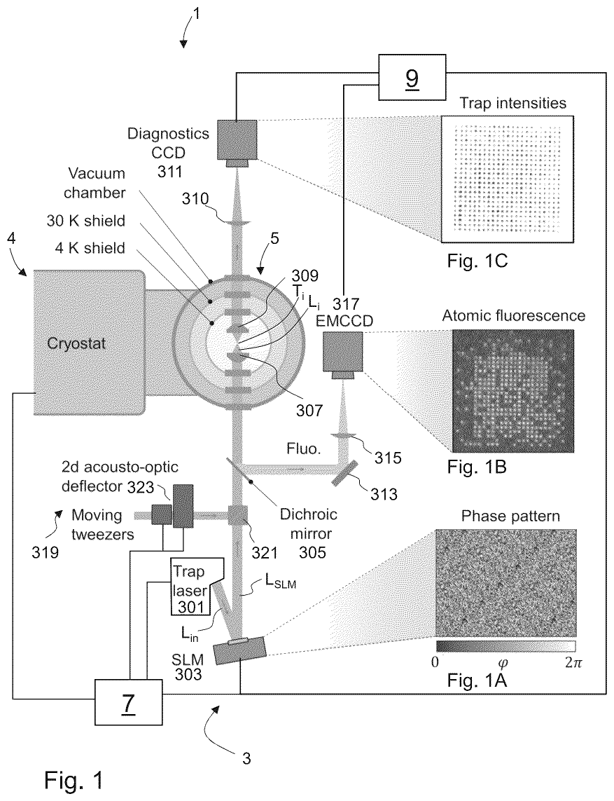

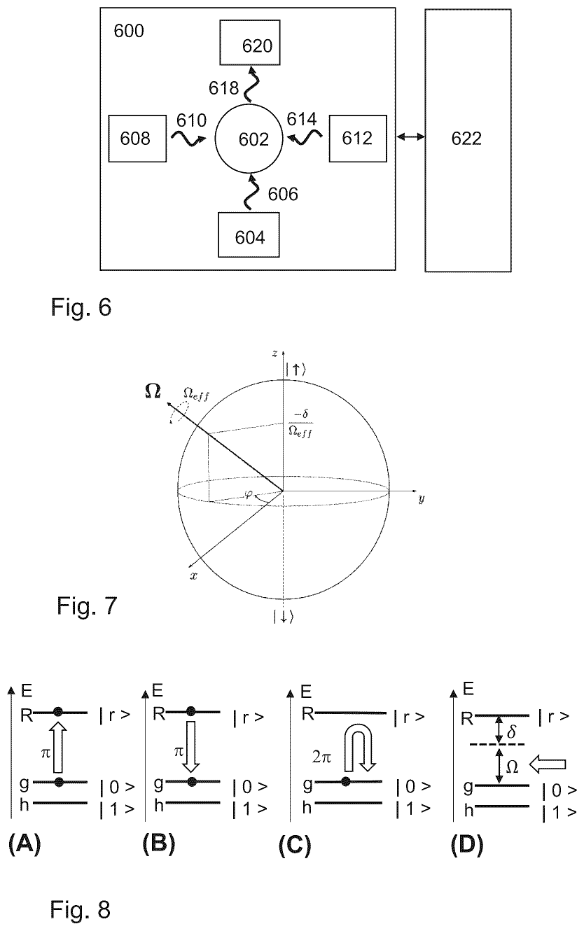

FIG. 1 indicates an exemplary system 1 employing, and/or for use with, the present concepts. The system 1 may be used for studying and/or manipulating any optically trappable object, and in particular for performing quantum operations on and/or with such objects, e.g. at least as part of a quantum computer (e.g. see also FIG. 6-8).

The system 1 comprises an optical system 3 for generating a plurality of optical traps Tᵢ in a sample holding system 4. At least part of the optical system 3 may be arranged in the sample holder system 4 such as a chamber 5 (also referred to as “science chamber” 5) which may be a vacuum-and/or cryogenic chamber. One or more parts of the system 1 may be connected to one or more controllers 7, 9 which may be connected and/or integrated. One or more of the controllers may comprise a memory and may be programmable to perform method steps as disclosed herein. Such memory may also be used to store particular operation settings and/or measurement data. One or more of the controllers may be remote from the optical system and/or be connected via internet connections.

One or more of the controllers 7, 9 may comprise or be comprised in a computer, and/or serve for performing classical operations in combination with quantum operations being performed using objects trapped in the plurality of optical traps provided by the optical system 3, as set out below, as a quantum processor.

The optical system 3 comprises a light source 301, a spatial light modulator “SLM” 303, a first beam splitter 305 which may be a dichroic mirror, focusing optics 307, e.g. an aspheric lens and/or lens array, optional further focusing optics 309, optional focusing optics 310, a first camera 311 “diagnostics CCD”, optional beam direction optics 313, optional focusing optics 315, and a second camera 317, here as an option an “electron-multiplication CCD camera” or “EMCCD”. Further, optional second light source 319 and second beam splitter 321 are provided. The system may comprise only one of the first and second cameras 311, 317. Also, or alternatively, the system may comprise more or fewer optical elements such as mirrors, lenses, polarisers, beam splitters, filters, controllable beam steering device such as one or more of acousto- and/or electro-optical elements, etc.

The light source 301 preferably comprises a laser, and generates an initial beam of light Lᵢₙ, directed onto the spatial light modulator 303 by suitable optical elements (not shown), to provide SLM-modified light L_{SLM}. The spatial light modulator 303 and the focusing optics 307 divide the initial beam of light Lᵢₙ into a plurality of optical trapping beams Lᵢ, focused into a plurality of optical traps Tᵢ in a trapping array (not separately shown). In some of the traps Tᵢ an object may be trapped, e.g. a neutral atom.

The second light source 319 may comprise a light source proper, e.g. a laser (not shown) and a controllable beam steering device such as one or more of acousto-and/or electro-optical elements 323.

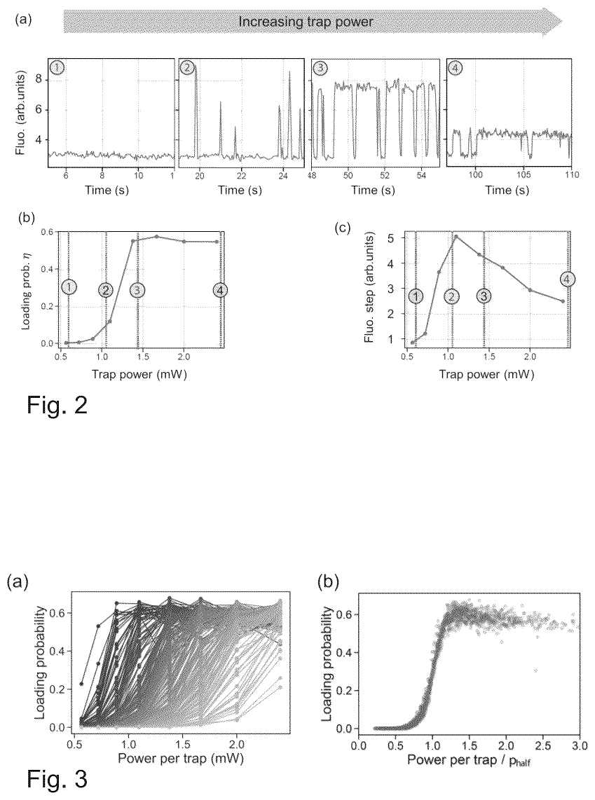

An embodiment of the cryogenic experimental setup has been described in K.-N. Schymik et al., “Single Atoms with 6000-Second Trapping Lifetimes in Optical-Tweezer Arrays at Cryogenic Temperatures”, Phys. Rev. Applied 16, 034013 (2021). and is sketched on FIG. 2. In brief, the embodiment comprises a closed cycle, UHV compatible cryostat at 4 K and allows to achieve extremely high vacuum levels and reaching about 6000 s lifetimes for atoms trapped in the optical traps Tᵢ. The science chamber 5 contains aspheric lenses 307, 309 (numerical aperture NA=0.5, focal length 10 mm, working distance 7 mm) allowing to tightly focus the trapping beam down to a 1/e² radius of a micrometer-scale, e.g. about 1 micrometer.

In this example, the trapping light is generated by the light source 301, which e.g. may comprise a Titanium-sapphire laser operating at 815 nm, but other light sources and/or wavelengths may be provided. As an option, an optical fiber, e.g. a single mode fiber, may used for providing the light Lᵢₙ from the source 301 onto the SLM 303. After diffraction of the light Lᵢₙ on the SLM 303, the light may be sent into the cryostat chamber 5 to provide the traps Tᵢ. In an example, the light beam L_{SLM} may provide well over a Watt, e.g. up to 1.8 W, optical power into the cryostat chamber 5, for division over the optical traps Tᵢ.

The SLM 303 may be, as an option, operated on the basis of a hologram. For SLM hologram calculation, a Weighted Gerchberg-Saxton (WGS) algorithm may be used in particular (see e.g. D. Kim et al., “Large-Scale Uniform Optical Focus Array Generation with a Phase Spatial Light Modulator”, Optics Letters 44, 003178 (2019)).

The arrays of traps Tᵢ thus produced can be assessed using the diagnostics CCD camera 311 onto which the trap array is imaged using the optics 309, 310, e.g. comprising aspheric lenses.

Neutral atoms trapped in the optical traps Tᵢ may fluoresce (or: may be made to fluoresce by suitable (additional) illumination). The fluorescence can be separated from the trap light using one or more suitable beam splitters, e.g. filters and/or dichroic mirrors. The fluorescence can be detected on one or more cameras 311, 317. In the example, the atomic fluorescence is collected through the first lens (e.g. an asphere) 307 which is also used to focus down the tweezers, separated from the trap light with the dichroic mirror 305, and imaged onto the electron-multiplication (EMCCD) camera 317.

In this case, the inset FIGS. 1A, 1B, 1C, respectively show, from bottom to top, a phase pattern used to produce a 23×23 square array with a spacing of 5 micrometer in the chamber 5, an atomic fluorescence image of atoms loaded in the thus produced array of traps Tᵢ obtained on the EMCCD camera 317, and an image of the trap intensities obtained on the diagnostics CCD camera 311 (i.e. detecting the trapping light rather than the fluorescence of trapped objects). Note that (at the position of) camera 317 also fluorescence can possibly be detected, if need be using suitable optical filtering.

Note further that different phase patterns may produce different numbers of traps, and even up to hundreds of traps may be produced in parallel from a single initial beam Lᵢₙ.

Further, the system 1 may comprise (not shown) additional parts such as additional optical systems and/or systems for controllably providing one or more electromagnetic fields for manipulating one or more objects trapped in the optical traps Tᵢ, e.g. per individual object and/or per group(s) of objects.

As set out before, equalization of the trap on the basis of the trap intensities (e.g. using the image of camera 311) may be employed but further improvement is required, and is provided by the present concepts.

FIG. 2. Indicates effects of the trap depth on loading single-atoms into a trap. The trap depth is varied by varying trap power, maintaining other optical parameters. Panel (a) shows time dependent fluorescence traces of a single atom trap for increasing depths of the optical trap. Each fluorescence step represents trapping or loss of an atom in the trap. Panel (b) shows evolution of the loading rate n of a trap as a function of the trap power; the data points indicate average trap occupancies derived from fluorescence measurements over a certain period such as several seconds or tens of seconds, e.g. see traces of panel (a). Panel (c) shows evolution of an amplitude of the fluorescence signal of a single atom as a function of the trap power. Clearly, four regimes 1-4 can be discerned, as indicated in the panels (a), (b), (c). At no or small power (regime 1), no atom can be trapped in the trap. As the trap power increases in regime 2, occasionally atoms get trapped and fluoresce, but the atoms also rapidly are lost, hence the effective trap loading rate n is low. At higher trap powers, regime 3, here typically around 1.5 mW optical trap power, both a high trapping probability and long trap life time are achieved leading to relatively high trap loading rate n of ca 55%, with a high value of the fluorescence signal that makes it easy to discriminate between the presence and the absence of an atom. At still higher trap power (regime 4), while the loading rate n remains roughly constant, an increased light-shift experienced by the atoms in the tweezers reduces the fluorescence signal. Finally, at very large powers (not shown) the tweezers start to accommodate several atoms as light assisted collisions become inefficient. Operation in regime 3 may therefore be preferred.

In a plurality of optical traps, differences between the optical traps may be minimised on the basis of the loading rates.

Preferably, the minimisation is done on the basis of a fitting function. E.g. it has been found that the power dependent trap loading rate behavior η(p) for the trap (FIG. 2(b)) may be approximated by the following error function:

$$η ( p ) = 1 / 2 {η}_{max} \{ Erf [ α ( p - {P}_{half} ) ] + 1 \} \qquad ( 3 )$$

wherein ηₘₐₓ is the maximum loading rate for the trap (ca 0.55 in FIG. 2(b)) and P_{half} is a fit parameter for the trap indicating half the power at which the trap reaches its asymptotic maximum loading rate ηₘₐₓ (P_{half} is ca 1.2 mW in FIG. 2(b)).

For an array of optical traps, such analysis may be done for each trap i individually, but preferably it is done in parallel for multiple traps.

It has been found that for a plurality of optical traps i in parallel, the power dependent trap loading rate η(p) (FIG. 2b) for each trap i has the same basic growth behavior (same basic shape). A comparison of the loading rates of plural traps allows normalisation and equalizing of the traps.

FIG. 3(a) shows an assembly of power dependent trap loading rates ηᵢ(p) determined of an array of 25×25 optical traps i. FIG. 3(b) again shows the determined loading rates ηᵢ(p), each rescaled by the respective value of p_{half,i} from a fit of the individual curves of panel (a) by equation (3) above. All rescaled data collapse on a universal curve. A trap power pᵢ of a given trap i may therefore be controlled and adjusted with respect to its p_{half,i} value to achieve a predictable trap loading rate ηᵢ of the trap i, e.g. its maximum loading rate η_{max,i}. Thus adjusting of at least some of the traps i (e.g. i=1, 2, 3, etc.) the respective trap intensity pᵢ to a further trap intensity p_{i,new} based on the trap loading rate ηᵢ of each trap i, in particular p_{half,i}, allows minimizing trap loading rate differences of the traps with respect to each other.

In an experimental setup as in FIG. 1, an initial beam of light Lᵢₙ is divided over all optical traps by the SLM.

FIG. 4(a) shows a heat map of the loading rates of 961 traps without implementing specific optimization procedure, illustrating how significant optical aberrations can affect the loading rate of the tweezers. The maximum value of the loading rate is about 50-60%. The value is maximal for the traps near the center of the array, which is close to the optical axis of the system, while at the edges the loading rate is poor. This is correlated with the optical aberrations in the tweezer shapes. FIG. 4(b) shows corresponding loading rates ηᵢ(p).

In case of such division it is preferred that the power for each trap is determined with respect to the average power per trap. The fit function for each trap then may become, as indicated above,

$${η}_{i} ( p ) = 1 / 2 {η}_{max , i} \{ Erf [ α ( {p}_{avg} - {P}_{half , i} ) ] + 1 \} \qquad ( 4 )$$

p_{avg} preferably is the average intensity per trap determined from the power Pₜₒₜ of the initial beam Lᵢₙ divided by the number Nₜₒₜ of traps Tᵢ produced from Lᵢₙ by the SLM 303. The fit parameter P_{half,i} of each trap also corresponds to the power required by each trap for achieving the desired loading rate.

In an embodiment, for equalization of the trap loading rates, for each trap the power dependent loading rate ηᵢ(p) is determined as a function of the power Pₜₒₜ, which can be done simultaneously, and the values p_{half,i} are determined. Then, for adjustment of the trap power of one or more traps a new hologram is calculated, using the controller 9 (and or 7), for the SLM 303, in particular using the Weighted Gershberg-Saxton algorithm with updated intensity weights wᵢ, proportional to p_{half,i} (while keeping a constant total power Pₜₒₜ and also maintaining the optical system constant otherwise): w_{i,new}=(Nₜ p_{half,i}/Pₜₒₜ)w_{i,old}. The new pattern is then applied to the SLM 303 using controller 9. Thus, the initial optical power Pₜₒₜ is redistributed differently over the optical traps to account for, and to counteract, the detected differences in loading rates. As a result the differences in loading rates are reduced. If need be, one or more repetitions may be applied.

FIG. 4.(c) and (d) show that (here: after a few iterations) the loading rates of all traps are largely equalized (the heat map in FIG. 4(c) is colored more uniformly than that in FIG. 4(a); variation in the loading rates of all traps is significantly reduced). The equalization may also or alternatively be determined from stabilisation of p_{half,i}-values and/or weight factors wᵢ (and/or, respectively C(p_{half,i}) correction functions) becoming constant from one iteration to the next. Suitable convergence may be established within several minutes or tens of minutes.

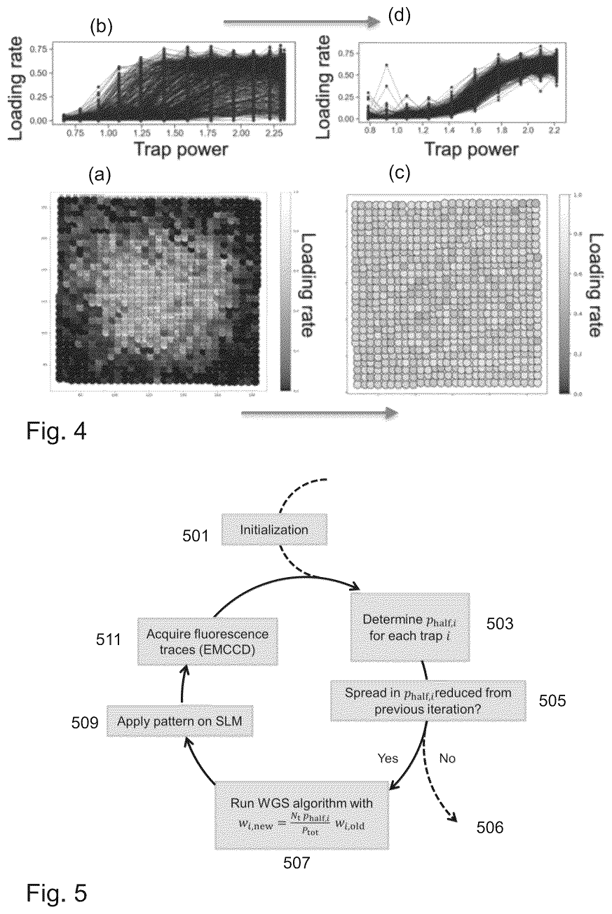

FIG. 5 schematically indicates an embodiment of the procedure. In step 501 the plurality of traps is produced by dividing an initial light beam Lᵢₙ into a plurality of light beams Lᵢ each providing an optical trap Tᵢ. The traps Tᵢ are optionally equalized using trap intensity detection. The trap intensities thereafter are controlled by controlling the trap power pᵢ by controlling the total optical power Pₜₒₜ, maintaining the optical system (e.g. alignment, wavelength, number of traps, etc.) generally constant otherwise; note that possible variations e.g. of the shape and/or position of the optical traps Tᵢ other than power changes due to changed phase patterns in the SLM 303 may be negligible in this respect.

Next, in step 503, the trap power dependent loading rate ηᵢ(p) of each trap i is determined as a function of the trap power Pₜₒₜ, a function ηᵢ(pᵢ|p_{half,i}) (e.g. Eq. (4)) is fit to the measured trap loading rates ηᵢ for each trap and the fit parameter p_{half,i} is determined for each trap i.

As an option, in step 505 convergence of the method may be determined, e.g. by determining a spread in p_{half,i}-values. In case of no convergence the method may be aborted in step 506. E.g. the system may checked for problems and/or the intensity initialisation may be restarted (not shown).

Next, in step 507, from the fit parameters, weights wᵢ for each trap mare determined, e.g. w_{i,new}=(Nₜ p_{half,i}/Pₜₒₜ)w_{i,old}. The weights wᵢ are used to calculate a correction function C(wᵢ), or C(p_{half,i}). for adjustment of the SLM 303, to update the trap intensities T_{i,old}=>T_{i,new} generated by the SLM 303, such that the new traps are calculated from the previous values, e.g. via a proportional feedback.

Next, in step 509 the adjusted phase pattern is applied to the SLM 303 and the adjusted traps are generated.

In step 511 optionally the fluorescence data of atoms trapped in the adjusted/new configuration is determined. If not satisfied and/or for checking the described sequence may be repeated one or more times.

Note that although rectangular arrays of traps are shown in the Figures, the present concepts may be employed with any arrangement of traps. Further, traps may be moved; then, at any position the method may be employed again.

Any embodiment in this application may be used in a neutral atom quantum processor which is based on configurable arrays of single neutral atoms (a neutral atom register).

FIG. 6 schematically describes an example of such neutral atom quantum processor. In particular, FIG. 6 depicts a high-level schematic of a neutral atom quantum processor 600 (quantum processor) which is controlled by a classical computer 622 and which is configured to execute the quantum circuits as described with reference to the embodiments in this application.

The quantum computer may include a chamber 602 that accommodates a plurality of neutral atoms. The atoms may be of the same element, and then thus are, from a chemical standpoint, identical when no external interactions are imposed upon them. The atoms may be unbound to other atoms in the plurality, for example, by being in a gaseous matter state. Particular suitable atoms that can be used as qubits and which are suitable for trapping, positioning and atomic-state-manipulating in a gaseous state may include (but not limited to) Rubidium or Cesium or Strontium (Alkali, Alkaline Earth, . . . ).

To control the quantum processor to execute operations, it may include different control and readout modules as shown in the figure. In particular, the quantum processor may include, in particular according to the description herein elsewhere, amongst others a trapping system 604 configured to trap atoms in a particular spatial arrangement within the chamber using trapping signals 606, an atom positioner 608 configured to controllably move one or more trapped atoms from one spatial position to another spatial position using positioning signals 608, an atomic state actuator 612 or in short an actuator configured to generated control signals 614, e.g. optical control pulses, to control and manipulate the atomic states of atoms in the chamber, and a detector 620 configured to detect and capture optical signals 618 transmitted by the atoms in the chamber. The detector may comprise a camera to image fluorescence output by the atoms held by the trapping system.

The trapping system 604 may be configured to trap atoms in a particular spatial arrangement. In particular, the trapping system may be configured to position (trap) each atom of the group of atoms at a particular position in the chamber such that they form a predetermined spatial arrangement in which atoms are isolated from each other if they are in a non-excited state, while atoms within a certain region may interact if they are in an excited state. Hence, the term ‘isolate’ in this context means that an atom in a non-excited atomic state does not interact with a neighboring atom of the same group. However, if the atoms are stimulated using, for example, an electromagnetic signal such as a laser pulse, they may be brought into an excited state, in which the atoms may interact with each other based on quantum mechanical effects such as (but not limited to) the Rydberg blockade.

The trapping system may be configured to maintain the atoms in their stationary positions using different mechanisms including, but not limited to, magnetically traps and optical traps. The trapping system may be configured to generate a pattern of spatially separated traps so that a particular spatial arrangement of atoms in the chamber can be realized. The trapping pattern may be an array of regular or irregular spaced traps. The trapping patterns may include 1D, 2D (insofar that the traps in the pattern all align along one plane) or 3D patterns of traps. For example, the trapping system may generate a 3D array of traps spaced periodically in the X, Y and Z dimensions to form a 3D grid. Other patterns are also possible. The spacing in one spatial dimension may be the same or different to the other spatial dimensions.

The trapping system may provide a plurality of trapping sites wherein, when the trapping system is first activated some trapping sites may be filled by one or more atoms whilst other trap sites are vacant. Preferably the trapping system may be configured to generate trapping sites that hold a single atom. The trapping system may use electromagnetic signals 606, such as optical trapping signals to generate the optical traps in the chamber.

The atom positioner 608 may be configured to controllably move one or more held atoms from one spatial position to another spatial position. For example, in an embodiment, the atom positioner may include one or more optical tweezers configured to use optical signals 610 to move one or more trapped atoms in one of the trapping sites to another trapping site. Different technologies may be used to manipulate the position of the atoms including, but not limited to, moving the atoms using magnetic signals or electromagnetic signals such as optical signals.

The atomic state actuator 612 may be configured to generate optical pulse signals to control and manipulate the atomic states of atoms in the chamber (in other words it “actuates” the transition between atomic states). The optical pulse signal 614 may include single or multiple photon signals. Different optical pulse signals may be output by the atomic state actuator including optical pulse signals at different wavelengths. Each wavelength may correspond to (i.e., be resonant with) a different atomic transition. Typically, the quantum processor may comprise multiple atomic state actuators. For example, a first atomic state actuator may output a first wavelength or first set of wavelengths which are different from the wavelength or set of wavelengths outputted by a second atomic state actuator. The atomic state actuator may facilitate the transition between atomic states of a single trapped atom or a plurality of trapped atoms. The wavelengths may be selected based on the atoms in the chamber. The excitation from the ground state to the Rydberg state may be facilitated by two-photon absorption. This may be accomplished using two different EM sources such as lasers or other EM sources. These two EM sources may have different wavelengths. For example, optical control pulses of 495 nm may be used for exciting a Rubidium atom to the Rydberg state and optical control pulses of 795 nm to induce transitions between the hyperfine states.

Suitable signals for trapping and moving the atoms are preferably different, at least in wavelength, to the signals used to manipulate the quantum states of the atoms. In particular, signals for trapping and moving the atoms may be off-resonance, i.e., the wavelength of the optical signals for trapping and positioning an atom cannot excite the atom between its different atomic states.
An example of the general operation of the quantum processor may include one or more of the following steps.
1) Using the trapping system to generated optical trapping signals to create a plurality of traps in the chamber so that atoms in the chamber are trapped.
2) Optionally using the atom positioner to manipulate, e.g. move, trapped atoms so that each trap of at least a predetermined set of traps can be filled with a single atom. Such set of single atom filled traps may be referred to as a ‘register’. The detector may be used in this process to help identify which traps are occupied or vacant.
3) Using the atomic state actuator to generate predetermined optical control pulses 614, e.g. laser pulses of a predetermined shape, amplitude and duration to control the atomic states of atoms in the register. This step may be performed multiple times to implement processing operations of the quantum processor, for example, time-sequentially inputting a plurality of optical pulses that represent quantum logic gate operations.
4) Using the detector to detect and image florescent signals emitted by the atoms and using the imaged signals to determine the atomic states of the atoms.

These steps may represent a quantum computation by the quantum processor. The quantum processor may be re-set by removing the traps and re-initialised for a further quantum computation by repeating steps 1-4 above.

The register of atoms described above that is operated on to perform quantum computing operations may be referred to as the ‘register’. Furthermore, it is to be understood that any quantum operations made on the register, according to a desired quantum algorithm, may be repeated one or more times to reconstruct the relevant statistical properties of the final quantum state produced. This is typically done because of the probabilistic nature of each possible outcome imposed by quantum mechanics.

As described above, the quantum states of the atoms may be controlled by atomic state actuators. Typically, these atomic state actuators may be implemented as lasers, however other actuators may be used. As will be described hereunder in more detail, the quantum processor may be used for analog computing where laser signals are applied to the atoms to realise a Hamiltonian. The quantum processor may also be used for digital computing wherein a quantum algorithm is decomposed into a plurality of quantum logic gates, which are executed successively in time. The quantum gates are realised by exposing individual atoms in the register with predetermined laser pulse signals.

The two qubit states that may be used are the hyperfine ground states of an atom, such as a rubidium atom. Hyperfine states of other atoms may be used in the alternative. These ground states have long or infinite lifetimes that prevent radiative coupling to the electromagnetic environment. This is advantageous because digital quantum computing requires qubits that are robust against decoherence. The spacing between atoms in the register may be several micrometers. The laser used for transitioning the atoms between these two hyperfine ground states may be a Raman laser. This laser and its output light may be referred to herein as the ‘Raman channel’. The quantum processor may use a plurality of Raman channels to address different atoms.

Quantum logic gates may be implemented by operating on a single qubit or operating on multiple qubits, such as two or more qubits. A single qubit gate may be implemented by having a laser act upon the atom wherein any single qubit gate may be implemented by tuning the properties of the incoming laser signal. This laser signal may also be referred to as a ‘control field’. By changing the properties of the control field, any arbitrary rotation of the qubit state, on the Bloch sphere as depicted in FIG. 7, may be performed. The atom-laser field interaction is affected by the Rabi frequency Ω (which proportional to the amplitude of the laser field); the detuning δ (the difference between the qubit resonance and the field frequencies) and their relative phase. Driving the control field for a duration t induces rotations around the (x, y, z) axes. Hence, any single-qubit gate can be implemented by tuning the pulse duration, the laser intensity, and detuning and the phase of the laser.

Thus, the transitions between atomic states, hence quantum states, of the atomic system, may be controlled by the transmission of electromagnetic control pulses by one or more electromagnetic sources. A control pulse may be defined as the modulation of a channel's output amplitude, detuning, and phase over a finite duration t. For a channel targeting the transition between energy levels a and b, with resonance frequency ω_{ab}=|Eₐ−E_{b}|/h, the output amplitude determines the Rabi frequency Ω(t), and the detuning δ(t), is defined relatively to ω_{ab} and the frequency of the channel's output signal ω(t), as δ(t)=ω(t)−ω_{ab}. Additionally, the phase φ of a pulse can be set to an arbitrary, constant value. A pulse-driven transition between two energy levels can be mapped to a spin-½ system through a drive Hamiltonian:

$${H}^{D} ( t ) = \frac{ℏ}{2} Ω ( t ) \cdot σ ,$$

where σ=(σ^{x}, σ^{y}, σ^{z})^{T} is the Pauli vector and Ω(t)=(Ω(t) cos(φ), −Ω(t) sin(φ), −δ(t))^{T} the rotation vector. As shown in FIG. 7, in the Bloch sphere representation, for each instant t, this Hamiltonian may be described by a rotation around the axis Ω with angular velocity (equation 32):

$${Ω}_{eff} = \vert Ω \vert = \sqrt{{Ω}^{2} + {δ}^{2}}$$

The above parameters for driving the control field may be controlled using direct digital synthesizers (DDS) that drive acousto-optic modulators (AOMs) and/or electro-optic modulators (EOM) placed on the laser beams or other electromagnetic sources. As an illustration, when driving the control field at resonance (δ=0), the qubit oscillates in time between the states |0 [symbol] and |1 [symbol] .

One-qubit gates are specific unitary transformations described by 2-by-2 complex matrices transforming one qubit state into another. Notable examples are the NOT-gate that changes the state |0 [symbol] into |1 [symbol] and vice-versa. Similarly, the Hadamard H gate is another single-qubit gate that generates superposition of both states starting from a pure state. The NOT gate may be implemented by a i rotation about the x axis in the Bloch sphere whilst the Hadamard gate may be implemented by a i rotation about the (x+z) axis.

Two-qubit gates are unitary transformations described by 4-by-4 matrices that transform one two-qubit state into another, allowing the generation of entanglement in the register. From a physics viewpoint, their implementation requires an interaction between the qubits. However, neutral atoms in their electronic ground state can only interact significantly via contact physical collisions. Single atoms are typically separated by a few micrometers in the register and therefore do not naturally ‘feel’ each other, therefore they do not normally interact. Two or more qubit gates described herein may cause different qubits to interact using Rydberg states, in particular by the Rydberg blockade. An atom in a Rydberg state or a ‘Rydberg atom’ is an excited atom with one or more electrons that have a very high principal quantum number n entailing that the electron is far from the nucleus and thus allows that atom to interact with another atom. The laser signal used to impart light at the wavelength need for the Rydberg transition may be referred to as the Rydberg laser. The Rydberg laser and its output light may be referred to herein as the ‘Rydberg channel’.

The disclosure is not restricted to the above described embodiments which can be varied in a number of ways within the scope of the claims.

Various embodiments may be implemented as a program product for use with a computer system, where the program(s) of the program product define functions of the embodiments (including the methods described herein). In one embodiment, the program(s) can be contained on a variety of non-transitory computer-readable storage media, where, as used herein, the expression “non-transitory computer readable storage media” comprises all computer-readable media, with the sole exception being a transitory, propagating signal. In another embodiment, the program(s) can be contained on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable [information is stored.

Elements and aspects discussed for or in relation with a particular embodiment may be suitably combined with elements and aspects of other embodiments, unless explicitly stated otherwise.

1. A method of controlling a plurality of optical traps (Tᵢ) comprising:
generating the plurality of optical traps (Tᵢ), each optical trap (“i”) having a trap intensity (pᵢ);
measuring trap loading rates (ηᵢ) for each trap (Tᵢ);
minimizing differences between trap loading rates (ηᵢ) of different traps (Tᵢ),
the minimizing comprising adjusting of at least some of the traps the trap intensity (pᵢ) to a further trap intensity (p_{i,new}) based on the trap loading rates (ηᵢ).

2. The method according to claim 1, wherein the measuring further comprises:
measuring the trap loading rates (ηᵢ) for each trap (i; Tᵢ) as a function of the trap intensity (pᵢ) and/or as a function of an overall trap intensity (Pₜₒₜ) for the plurality of optical traps (Tᵢ);
fitting a function to the measured trap loading rates (ηᵢ) for each trap and determining a fit parameter (p_{half,i}) for each trap; and
wherein the minimizing comprises adjusting of at least some of the traps (Tᵢ) the trap intensity (pᵢ) to the further trap intensity (p_{i,new}) based on the fit parameter (p_{half,i}).

3. The method according to claim 2, wherein the fit parameter (p_{half,i}) of at least one of the traps (i) is associated with a trap intensity (pᵢ) of that trap (i) with respect to at least one of a total intensity for all traps (Pₜₒₜ), a total intensity of all traps (Σ_{I} pᵢ), an average trap intensity (p_{avg,tot}=Pₜₒₜ/Nₜ) for the plurality of optical traps, and an average trap intensity (p_{avg,i}=Σᵢ pᵢ/Nₜ) of the plurality of optical traps.

4. The method according to claim 2, wherein the fitting further comprising determining the loading rate (η) as a function of a target loading rate (η_{max,i}) for at least one of the traps, in particular a maximum trap loading rate for at least one of the traps.

5. The method according to claim 2, wherein the fitting comprises fitting an error function (Erf) to the measured trap loading rates (ηᵢ) on the basis of:
$${η}_{i} ( p ) = 1 / 2 {η}_{max , i} \{ Erf [ α ( {p}_{avg} - {P}_{half , i} ) ] + 1 \}$$
wherein ηᵢ is a trap loading rate for a trap i, η_{max,i} is a maximum loading rate for the trap i, α is a constant, p_{avg} is an average intensity per trap (_{avg} preferably being p_{avg,tot} or p_{avg,i}), and p_{half,i} is the fit parameter for each trap.

6. The method according to claim 1, wherein the generating comprises generating the plurality of optical traps (Tᵢ) by distributing a light having a first optical intensity (Pₜₒₜ) among the traps, in particular dividing an initial light beam (Lᵢₙ) into a plurality of light beams each providing an optical trap.

7. The method according to claim 1, wherein the measuring further comprises measuring an optical signal, e.g. luminescence and/or scattering, of trapped target objects.

8. The method according to claim 1, wherein the measuring further comprises obtaining a signal indicative of a time averaged presence of a target object in the trap.

9. The method according to claim 1, wherein the generating comprises use of a holographic spatial light modulator, and
wherein preferably the minimizing comprises calculating a phase pattern for the holographic spatial light modulator according to the Weighted Gerchberg-Saxton algorithm and adjusting the phase pattern on the basis of w_{i,new}=(Nₜ p_{half,i}/Pₜₒₜ)w_{i,old}

10. The method according to claim 1, further comprising moving a trapped object from one of the traps to another one of the traps.

11. An optical trapping system comprising:
an optical system for generating a plurality of optical traps (Tᵢ);
a measuring unit for measuring trap loading rates (ηᵢ) for each (i) trap (Tᵢ); and,
a computer configured to execute the steps of:
generating, using the optical system, a plurality of optical traps (Tᵢ), each optical trap having a trap intensity (pᵢ);
measuring, using the measuring unit, trap loading rates (ηᵢ) for each trap;
minimizing differences between trap loading rates (ηᵢ) of different traps, the minimizing including adjusting the trap intensity (pᵢ) of at least some of the traps to a further trap intensity (p_{i,new}) based on the trap loading rates (ηᵢ).

12. The optical trapping system according to claim 11, further comprising a source of neutral atoms, molecules or ions for being trapped in the traps (Tᵢ).

13. The optical trapping system according to claim 11, wherein the optical system comprises a spatial light modulator for controllably distributing an optical intensity (Pₜₒₜ) from a light source among the traps.

14. A non-transitory computer-readable storage medium when executed by a processor execute a a method of controlling a plurality of optical traps (Tᵢ) comprising:
generating the plurality of optical traps (Tᵢ), each optical trap (“i”) having a trap intensity (pᵢ),
measuring trap loading rates (ηᵢ) for each trap (Tᵢ):
minimizing differences between trap loading rates (ηᵢ) of different traps (Tᵢ).
the minimizing comprising adjusting of at least some of the traps the trap intensity (pᵢ) to a further trap intensity (p_{i,new}) based on the trap loading rates (ηᵢ).

15. The quantum processor, preferably a neutral atom quantum processor, comprising an optical trapping system according to claim 11.
